(19) United States
(12) Patent Application Publication
(10) Pub. No.: US 2024/0037179 A1
(43) Pub. Date: Feb. 1, 2024

(54) DATA PROCESSING METHOD AND APPARATUS

(71) Applicant: Shanghai Biren Technology Co.,Ltd, Shanghai (CN)

(72) Inventors: Shuangshuang WU, Shanghai (CN); Yunpeng WANG, Shanghai (CN); Jun PENG, Shanghai (CN); Liucheng DUAN, Shanghai (CN); Hang YANG, Shanghai (CN); Xiaoyang LI, Shanghai (CN); Lingjie XU, Shanghai (CN); HaiChuan WANG, Shanghai (CN); Shu CHEN, Shanghai (CN)

(73) Assignee: Shanghai Biren Technology Co.,Ltd, Shanghai (CN)

(21) Appl. No.: 17/984,236

(22) Filed: Nov. 10, 2022

(30) Foreign Application Priority Data
Jul. 29, 2022 (CN) 202210909761.3

(51) Int. Cl. G06F 17/16

(52) U.S. Cl. CPC G06F 17/16

(57) ABSTRACT

A data processing method and data processing apparatus are provided. The data processing method includes: acquiring multiple input tensors as input parameters for calculation process; for each input tensor, using M input sub-tensors that are combined to represent the input tensor; for each of the input tensors, replacing the input tensors with the M input sub-tensors that are combined to represent the input tensor, and performing the calculation process to obtain a calculation result. The data processing method increases the applicable scenarios of calculation process, effectively utilizes the powerful calculation ability of the originally provided low-accuracy floating points, and greatly improves the overall calculation efficiency.

### CROSS-REFERENCE TO RELATED APPLICATION

This application claims the priority benefit of China application serial no. 202210909761.3, filed on Jul. 29, 2022. The entirety of the above-mentioned patent application is hereby incorporated by reference herein and made a part of this specification.

### BACKGROUND

### Technical Field

Embodiments of the present disclosure relate to a data processing method, a data processing apparatus, a processor, an electronic device, and a non-transitory computer-readable storage medium.

### Description of Related Art

A tensor is a multilinear map defined on the Cartesian product of some vector space and some dual space. For example, a scalar may be regarded as a 0-dimensional tensor, a vector may be regarded as a 1-dimensional tensor, and a matrix may be regarded as 2D tensor. Tensor operations are commonly used in processors such as parallel processors.

With the development of artificial intelligence and machine learning, new requirements have been imposed on parallel processor (e.g., multi-core processor, graphics processor, digital signal processor, etc.) as the representative of many parallel processor devices. The tensor operations of the parallel processor may include general matrix multiplication (GEMM) or convolution multiplication. For example, in neural network processing often adopted in artificial intelligence and other fields, for example, it is often required to perform matrix multiply and accumulation (MACC) calculation when it comes to convolutional neural networks, and MACC calculation also belong to a tensor operation. For example, MACC calculation includes multiplying corresponding position elements in two matrices, and then accumulating the multiplication results to obtain a calculation result.

### SUMMARY

At least one embodiment of the present disclosure provides a data processing method, including: acquiring multiple input tensors as input parameters for calculation process, and the multiple input tensors are of a first accuracy type; for each input tensor, using M input sub-tensors that are combined to represent the input tensor, and the M input sub-tensors have at least two different accuracy types, the at least two accuracy types and the first accuracy type are different from each other, M is an integer greater than 1; for each of the input tensors, replacing the input tensors with the M input sub-tensors that are combined to represent the input tensor, and performing the calculation process to obtain a calculation result.

For example, in a data processing method provided by at least one embodiment of the present disclosure, for each of the input tensors, the M input sub-tensors have the same shape as the input tensor. For each of the input tensors, the step of using the M input sub-tensors that are combined to represent the input tensor includes: for each parameter element in the input tensor, splitting the parameter element into M sub-elements, and the M sub-elements are the elements in the M input sub-tensors that have the same positions as the parameter elements in the input tensor, and the parameter elements are expressed as the sum of the M sub-elements.

For example, in a data processing method provided by at least one embodiment of the present disclosure, for each parameter element in the input tensor, the step of splitting the parameter element into M sub-elements includes: determining that the exponent and sign bit of the first sub-element in the M sub-elements are the same as the exponent and sign bit of the parameter element, and significant bits of mantissa of the first sub-element is the same as a preceding high-order significant bit part in significant bits of mantissa of the parameter element; determining other M−1 sub-elements in the M sub-elements except the first sub-element, and the sum of the other M−1 sub-elements is the difference between the parameter element and the first sub-element.

For example, in a data processing method provided by at least one embodiment of the present disclosure, the at least two accuracy types include a second accuracy type, the accuracy type of the first sub-element is the second accuracy type, and the total number of bits of the second accuracy type is N2, where N2 is a positive integer, and the binary representation of the first sub-element is the first N2 bits of the binary representation of the parameter element.

For example, in a data processing method provided by at least one embodiment of the present disclosure, in the significant bits of mantissa of the parameter element, the other significant bits of mantissa except the preceding high-order significant bit part are divided into consecutive M−1 segments, the other M−1 sub-elements correspond to the M−1 segments respectively, where the number of significant bits included in each segment is less than or equal to the number of significant bits of the mantissa of the sub-element corresponding to the segment. The step of determining other M−1 sub-elements in the M sub-elements except the first sub-element includes determining that the significant bits of the mantissa of each sub-element in the other M−1 sub-elements are the M−1 segments respectively; determining that the exponent of each of the other M−1 sub-elements is P-Qi, where P is the exponent of the parameter element, Qi is the difference in bits between the highest-order bit of the segment corresponding to the sub-element and the highest-order bit in the significant bit of mantissa of the parameter element, and P and Qi are integers.

For example, in a data processing method provided by at least one embodiment of the present disclosure, the number of significant bits of the mantissa of the first accuracy type is F1, and the at least two accuracy types include a second accuracy type and a third accuracy type. The number of significant bits of the mantissa of the second accuracy type is F2, the number of significant bits of the mantissa of the third accuracy type is F3, and F1, F2 and F3 are positive integers. The other M−1 sub-elements include the second sub-element, and the accuracy type of the second sub-element is the third accuracy type. The step of determining that the significant bits of the mantissa of each of the other M−1 sub-elements are respectively the M−1 segments includes: in response to F1-F2 being less than or equal to F3, determining that M−1 is 1, and determining that the high-order F1-F2 bits in the mantissa of the binary representation of the second sub-element are the same as the F1-F2-1-th to the 0-th bit in the mantissa part of the binary representation of the parameter element; in response to F1-F2 being greater than F3, determining that the mantissa of the binary representation of the second sub-element is the same as the F1-F2-F3-1-th to F1-F2-1-th bits in the mantissa part of the binary representation of the parameter element.

For example, in a data processing method provided by at least one embodiment of the present disclosure, in response to F1-F2 being greater than F3, F1 is equal to the sum of the number of significant bits of the mantissa in the respective accuracy types of the M sub-elements.

For example, in a data processing method provided by at least one embodiment of the present disclosure, the calculation process at least includes a convolution operation or a matrix multiplication operation, and the number of significant bits of the mantissa of the first accuracy type is F1, and F1 is a positive integer. The at least two accuracy types include a second accuracy type and a third accuracy type. For each input tensor, the step of replacing the input tensors with the M input sub-tensors that are combined to represent the input tensor, and performing the calculation process to obtain the calculation result includes: replacing each input tensor in the calculation process with the sum of the M input sub-tensors that are combined to represent the input tensor according to the calculation process, and expanding to obtain L first intermediate results, and each first intermediate result is expressed as the multiplication or convolution of two input sub-tensors, where L is a positive integer greater than 1; determining the L exponents respectively corresponding to the L first intermediate results and the largest exponent among the L exponents; selecting at least one first intermediate result from the L first intermediate results according to the L exponents, and an absolute value of a difference between the exponent of the at least one first intermediate result and the largest exponent is less than or equal to F1; taking the sum of the at least one first intermediate result as the calculation result.

For example, in a data processing method provided by at least one embodiment of the present disclosure, the calculation process at least includes a convolution operation or a matrix multiplication operation, and the number of significant bits of the mantissa of the first accuracy type is F1, and F1 is a positive integer. The at least two accuracy types include a second accuracy type and a third accuracy type. For each input tensor, the step of replacing the input tensors with the M input sub-tensors that are combined to represent the input tensor, and performing the calculation process to obtain the calculation result includes: replacing each input tensor in the calculation process with the sum of the M input sub-tensors that are combined to represent the input tensor according to the calculation process, and expanding to obtain L first intermediate results, and each first intermediate result is expressed as the multiplication or convolution of two input sub-tensors; for each of at least some of the input sub-tensors that are of the second accuracy type in the L first intermediate results, using combined W intermediate sub-tensors whose type is the third accuracy type to represent the input sub-tensors whose type is the second accuracy type, so as to obtain U second intermediate results, where L and U are positive integers; determining the U exponents respectively corresponding to the U second intermediate results and the largest exponent among the U exponents; selecting at least one second intermediate result from the U second intermediate results according to the U exponents, where an absolute value of a difference between the exponent of the at least one second intermediate result and the largest exponent is less than or equal to F1; taking the sum of the at least one second intermediate result as the calculation result.

For example, in a data processing method provided by at least one embodiment of the present disclosure, for each of at least some of the input sub-tensors that are of the second accuracy type in the L first intermediate results, the step of using combined W intermediate sub-tensors whose type is the third accuracy type to represent the input sub-tensors whose type is the second accuracy type, so as to obtain U second intermediate results includes: determining the L exponents respectively corresponding to the L first intermediate results; selecting the largest value from the L exponents, determining L−1 first intermediate results other than the first intermediate result corresponding to the largest value among the L first intermediate results; in V first intermediate results which include input sub-tensors whose type is the second accuracy type among the L−1 first intermediate results, replacing the input sub-tensor whose type is the second accuracy type in each of the V first intermediate results with the sum of the W intermediate sub-tensors whose type is the third accuracy type, expanding to obtain W third intermediate results corresponding to each of the V first intermediate results, where the third intermediate result is expressed in the form of the multiplication or convolution of the input sub-tensor whose type is the third accuracy type and the intermediate sub-tensor, and V is a positive integer; and taking all third intermediate results corresponding to the V first intermediate results, the first intermediate result corresponding to the largest value, and L−1−V first intermediate results other than the V first intermediate results among the L−1 first intermediate results as the U second intermediate results.

For example, in a data processing method provided by at least one embodiment of the present disclosure, the first accuracy type and the at least two accuracy types are both floating point types.

For example, in a data processing method provided by at least one embodiment of the present disclosure, the number of exponents digits in the first accuracy type is the same as the number of exponents digits in the at least two accuracy types.

For example, in a data processing method provided by at least one embodiment of the present disclosure, the accuracy of the first accuracy type is higher than the accuracy of any one of the at least two accuracy types.

For example, in a data processing method provided by at least one embodiment of the present disclosure, the first accuracy type is FP32, the at least two accuracy types include BF16 and BF24. The number of digits of the exponent part of the BF16 is 8, the number of significant bits of the mantissa part of the BF16 is 8, the number of digits of the exponent part of the BF24 is 8, the number of significant bits of the mantissa part of the BF24 is 16, and each of the input tensors is represented by using a combination of one input sub-tensor whose type is BF16 and one input sub-tensor whose type is BF24.

At least one embodiment of the present disclosure further provides a data processing method, including: receiving first data, where the first data is of a first accuracy type; representing the first data by using a combination of M sub-data; replacing the first data with the combination of the M sub-data for subsequent processing, where the M data has at least two different accuracy types, and the at least two accuracy types and the first accuracy type are different from each other, and M is an integer greater than 1. The first accuracy type and the at least two accuracy types are both floating point types. The number of exponent digits in the first accuracy type is the same as the number of exponent digits in the at least two accuracy types. The accuracy of the first accuracy type is higher than the accuracy of any one of the at least two accuracy types.

At least one embodiment of the present disclosure further provides a data processing apparatus, including: an acquisition module configured to acquire multiple input tensors as input parameters for calculation process, where the multiple input tensors are of the first accuracy type; a first processing module configured to, for each of the input tensors, represent the input tensor by using a combination of M input sub-tensors, where the M input sub-tensors have at least two different accuracy types, the at least two accuracy types and the first accuracy type are different from each other, and M is an integer greater than 1; a second processing module configured to, for each of the input tensors, replace the input tensor with the M input sub-tensors that are combined to represent the input tensor, perform the calculation process, and obtain a calculation result, where the first accuracy type and the at least two accuracy types are both floating point types, and the number of exponent digits in the first accuracy type is the same as the number of exponent digits in the at least two accuracy types, and the accuracy of the first accuracy type is higher than the accuracy of any one of the at least two accuracy types.

At least one embodiment of the present disclosure further provides a processor, including the data processing apparatus according to any embodiment of the present disclosure.

At least one embodiment of the present disclosure further provides a data processing method, including: receiving a data calculation instruction, where the data calculation instruction includes a plurality of input tensors as calculation input parameters, and after parsing the data calculation instruction, using a data processing unit to execute the data calculation instruction, where the step of using the data processing unit to execute the data calculation instruction includes: acquiring multiple input tensors as input parameters of the calculation process, where the multiple input tensors are of the first accuracy type; for each input tensor, using the M input sub-tensors that are combined to represent the input tensor, where the M input sub-tensors have at least two different accuracy types, the at least two accuracy types and the first accuracy type are different from each other, and M is an integer greater than 1; for each of the input tensors, replacing the input tensors with the M input sub-tensors that are combined to represent the input tensor, and performing the calculation process to obtain a calculation result, where the first accuracy type and the at least two accuracy types are both floating point types, the number of exponent digits in the first accuracy type is the same as the number of exponent digits in the at least two accuracy types, the accuracy of the first accuracy type is higher than the accuracy of any one of the at least two accuracy types.

At least one embodiment of the present disclosure further provides a processor, including an instruction parsing unit and a data processing unit, where the instruction parsing unit is configured to receive and parse a data calculation instruction, where the data calculation instruction includes multiple input tensors as calculation input parameters. The data processing unit executes the data processing method according to any embodiment of the present disclosure after the instruction parsing unit parses the data calculation instruction.

At least one embodiment of the present disclosure further provides an electronic device, including: a memory, which non-transitorily stores computer-executable instructions; a processor, which is configured to execute the computer-executable instructions, where the computer-executable instructions implement the data processing method according to any embodiment of the present disclosure when being executed by the processor.

At least one embodiment of the present disclosure further provides a non-transitory computer-readable storage medium, where the non-transitory computer-readable storage medium stores computer-executable instructions, and the computer-executable instructions implement the data processing method according to any embodiment of the present disclosure when being executed by the processor.

### BRIEF DESCRIPTION OF THE DRAWINGS

In order to explain the technical solutions of the embodiments of the present disclosure more clearly, the accompanying drawings of the embodiments will be briefly introduced below. Clearly, the drawings in the following description only relate to some embodiments of the present disclosure, rather than limit the present disclosure.

FIG. 1 is a schematic flowchart of a data processing method provided by at least one embodiment of the present disclosure.

FIG. 2A is a schematic diagram of a data format of a parameter element provided by at least one embodiment of the present disclosure.

FIG. 2B is a schematic diagram of a data format of a parameter element provided by at least one embodiment of the present disclosure.

FIG. 3 is a schematic diagram of a relationship between parameter elements and sub-elements provided by at least one embodiment of the present disclosure.

FIG. 4A is a schematic flowchart of step S30 provided by at least one embodiment of the present disclosure.

FIG. 4B is a schematic diagram of a mixed-accuracy simulation processing process provided by at least one embodiment of the present disclosure.

FIG. 5A is a schematic flowchart of step S30 provided by at least one embodiment of the present disclosure.

FIG. 5B is a schematic diagram of a mixed-accuracy simulation processing process provided by at least one embodiment of the present disclosure.

FIG. 6 is a flowchart of a data processing method provided by at least one embodiment of the present disclosure.

FIG. 7A is a schematic block diagram of a data processing apparatus according to at least one embodiment of the present disclosure.

FIG. 7B is a schematic block diagram of a data processor according to at least one embodiment of the present disclosure.

FIG. 8 is a schematic structural diagram of a processor provided by at least one embodiment of the present disclosure.

FIG. 9 is a schematic diagram of a non-transitory computer-readable storage medium provided by at least one embodiment of the present disclosure.

FIG. 10 is a schematic block diagram of an electronic device according to an embodiment of the present disclosure.

### DESCRIPTION OF THE EMBODIMENTS

In order to make the purposes, technical solutions and advantages of the embodiments of the present disclosure more clear, the technical solutions of the embodiments of the present disclosure will be clearly and completely described below with reference to the accompanying drawings of the embodiments of the present disclosure. Clearly, the described embodiments are some, but not all, embodiments of the present disclosure. Based on the described embodiments of the present disclosure, all other embodiments obtained by those of ordinary skill in the art without creative efforts fall within the protection scope of the present disclosure.

Unless otherwise defined, technical or scientific terms used in this disclosure shall have the ordinary meaning as understood by one of ordinary skill in the art to which this disclosure belongs. As used in this disclosure, “first,” “second,” and similar terms do not denote any order, quantity, or importance, but are merely used to distinguish the various components. “Comprises” or “comprising” and similar words mean that the elements or things preceding the word encompass the elements or things recited after the word and their equivalents, but do not exclude other elements or things. Words like “connected” or “linked” are not limited to physical or mechanical connections, but may include electrical connections, whether direct or indirect. “Up”, “Down”, “Left”, “Right”, etc. are only used to represent the relative positional relationship, and when the absolute position of the described object changes, the relative positional relationship may also change accordingly.

In order to keep the following description of the embodiments of the present disclosure clear and concise, the present disclosure omits a detailed description of some commonly-known functions and commonly-known components.

Floating point (FP) is mainly used to represent decimals, and typically consists of three parts, namely the sign bit, the exponent part and the mantissa part, the exponent part may also be called the jie-ma part (literal translation in Chinese). For example, a floating point V may usually be represented as follows:

V=(−1)^{s}×M×2^{E}

The sign bit s may be 1 bit, which determines whether the floating point V is a negative number or a positive number; M represents the mantissa part, which may include multiple bits, and are in the form of binary decimals and define the accuracy of the floating point; E indicates the exponent (also called the exponent value), which is used to weight the floating point, reflects the position of the decimal point in the floating point V, and defines the value range of the floating point.

For example, conventional floating point typically include three formats, namely half-accuracy floating point (FP16), single-accuracy floating point (FP32), and double-accuracy floating point (FP64), which have different number of digits in the exponent part and the mantissa part.

For normalized floating points, the number of significant bits in the mantissa thereof is the number of digits in the mantissa part plus 1. For example, for a single-accuracy floating point, the mantissa part thereof includes 23 bits, the significant bits of the mantissa thereof are 24 bits, and the most significant bit is 1.

GPU (Graphic Process Unit), AI accelerator, etc. have been commonly adopted in deep learning model training. For the common tensor operations in deep learning models, GPU manufacturers have made special optimizations in software and hardware design to accelerate calculation. For example, some GPU and AI accelerator manufacturers provide specialized data processing apparatuses to optimize tensor calculation. For example, the data processing apparatus may include tensor cores, and the use of tensor cores significantly increases data throughput and improves calculation efficiency.

For example, a data processing apparatus such as a tensor core supports various calculation processes, such as conventional numerical operations, matrix multiplication, convolution multiplication, and the like. In addition, the data processing apparatus has optimized and developed a variety of floating point data formats for artificial intelligence/deep learning and other fields, such as BF16 (brain floating point 16, with a bit width of 16 bits), BF24 (brain floating point 24, with a bit width of 24 bits), TF32 (tensor float 32, with a bit width of 19 bits), etc. These data formats may significantly reduce the computing resources and power consumption required for calculation processing, especially matrix multiplication or convolution multiplication. In addition, the data processing apparatus also supports some conventional floating point, such as half-accuracy floating point (FP16, with a bit width of 16 bits) or double-accuracy floating point (FP64, with a bit width of 64 bits), etc.

However, similar to single-accuracy floating point (FP32, with a bit width of 32 bits) as a common data type, a data processing apparatus, such as tensor core, do not directly support single-accuracy floating point format. Nonetheless, using single-accuracy floating point to perform calculation process is a very important basic operation in high-performance calculation such as artificial intelligence and data analysis. If GPUs, AI accelerators, etc. cannot support such operations, the applicability of these devices will be affected.

At least one embodiment of the present disclosure provides a data processing method, a data processing apparatus, a processor, an electronic device, and a non-transitory computer-readable storage medium. The data processing method includes: acquiring multiple input tensors as input parameters for calculation process, and the multiple input tensors are of a first accuracy type; for each input tensor, using the M input sub-tensors that are combined to represent the input tensor, and the M input sub-tensors are of at least two different accuracy types, the at least two accuracy types and the first accuracy type are different from each other, M is an integer greater than 1; for each of the input tensors, replacing the input tensors with the M input sub-tensors that are combined to represent the input tensor, and performing the calculation process to obtain a calculation result.

In the data processing method provided by at least one embodiment of the present disclosure, multiple low-accuracy input sub-tensors of mixed-accuracy types are adopted to simulate high-accuracy input tensors, so that the processor using the data processing method supports the calculation of high-accuracy data formats that might not be supported originally, thereby increasing the applicable scenarios of calculation process, improving the applicability of processors that apply this data processing method, and effectively utilizing the powerful calculation ability inherently processed by the originally provided low-accuracy floating point. In this manner, such method will not increase the overall calculation time of calculation process, but also may greatly improve the overall calculation efficiency. In addition, during the execution of the data processing method, the upper-layer application software, such as artificial intelligence application, is decoupled, and the upper-layer application does not perceive the specific implementation of the data processing method, so that the cost of software adaptation may be significantly reduced.

The upper-layer application does not perceive the specific process of the data processing method, which can greatly reduce the cost of software adaptation.

The embodiments of the present disclosure will be described in detail below with reference to the accompanying drawings, but the present disclosure is not limited to these specific embodiments.

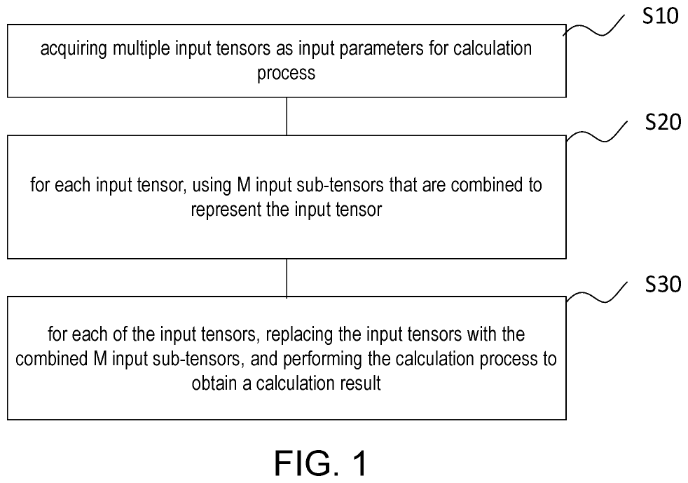

FIG. 1 is a schematic flowchart of a data processing method provided by at least one embodiment of the present disclosure.

As shown in FIG. 1, the data processing method provided by the embodiment of the present disclosure includes steps S10 to S30.

In step S10, multiple input tensors as input parameters of the calculation process are acquired.

For example, the multiple input tensors are of the first accuracy type.

For example, the input tensor may be obtained by reading the input parameter of the calculation instruction, or may also be obtained by reading pre-stored data as the input tensor, etc., which is not specifically limited in the present disclosure.

For example, the input tensor may be either a 0-dimensional tensor, which is a single floating point, or a 1-dimensional tensor, i.e., a scalar (array) whose type is floating point, or a 2-dimensional tensor (matrix) or higher dimensional tensors, which is not specifically limited in this disclosure.

In step S20, for each input tensor, M input sub-tensors are combined to represent the input tensor.

For example, the M input sub-tensors have at least two different accuracy types, the at least two accuracy types and the first accuracy type are different from each other, and M is an integer greater than 1.

In step S30, for each input tensor, M input sub-tensors are combined to replace the input tensor, and a calculation process is performed to obtain a calculation result.

For example, the calculation process may include matrix multiplication operations, convolution operations, conventional arithmetic operations, and the like, which are not specifically limited by the embodiments of the present disclosure. For example, when the input tensor is a two-dimensional tensor, the calculation process may be a matrix multiplication operation; when the input tensor is a multi-dimensional tensor, the calculation process may be a convolution operation; and conventional arithmetic operations may include addition, subtraction, etc.

Depending on the calculation process, the number of input tensors may also be adjusted accordingly. For example, the number of input tensors may be two, and the calculation process may be execution of a convolution operation of two input tensors. Of course, the number of input tensors may be more, for example, the calculation process may be execution of a convolution operation of two input tensors, and the convolution result is added to other input tensors, etc., the embodiment of the disclosure provides no specific limitation thereto.

For example, the first accuracy type and the above-mentioned at least two accuracy types are both floating point type, and the number of exponent digits (that is, the digits the exponent part or the jie-ma part) in the first accuracy type is the same as the number of exponent digits in the at least two accuracy types. The accuracy of the first accuracy type is higher than the accuracy of any one of the at least two accuracy types.

For example, since the number of exponent digits in the first accuracy type is the same as the number of exponent digits in the at least two accuracy types, the data range that can be represented is also the same, and the problem of data overflow will not occur.

For example, “the accuracy of the first accuracy type” is higher than “the accuracy of any one of the at least two accuracy types” means that the number of significant bits in the mantissa of the mantissa part of the first accuracy type is greater than the number of significant bits of the mantissa of the mantissa part of any one of the at least two accuracy types.

For example, the at least two different accuracy types mean that, assuming that at least two different accuracy types include n accuracy types, the number of digits in the exponent part of these n accuracy types is the same, but the number of significant bits of the mantissa of the mantissa part of the n accuracy types is different. Here, n is a positive integer and is greater than or equal to 2.

Of course, the first accuracy type and the at least two accuracy types are also necessarily different data formats.

For example, the first accuracy type may be a single-accuracy floating point FP32. Correspondingly, the above at least two accuracy types include BF24 and BF16, whose data formats are shown in Table 1 below:

TABLE 1
Data Format

| | Total | | | | Number of |
|---|---|---|---|---|---|
| Data | number | Sign | Exponent | Mantissa | significant bits of |
| format | of bits | bit | part | part | mantissa |
| FP32 | 32 | 1 | 8 | 23 | 24 |
| BF24 | 24 | 1 | 8 | 15 | 16 |
| BF16 | 16 | 1 | 8 | 7 | 8 |

As shown in Table 1, the first accuracy type is FP32, the total number of bits thereof is 32 bits, including 1 sign bit, the exponent part (that is, jie-ma) includes 8 bits, the mantissa part includes 23 bits, and the number of significant bits of the mantissa is 23+1=24 bits. The at least two accuracy types include BF24 and BF16, where the total number of bits for BF24 is 24 bits, including 1 sign bit, the exponent part (i.e., jie-ma) includes 8 bits, the mantissa part includes 15 bits, and the number of significant bits of the mantissa is 15+1=16 bits; the total number of bits for BF16 is 16 bits, including 1 sign bit, the exponent part (i.e., jie-ma) includes 8 bits, the mantissa part includes 7 bits, and the number of significant bits of the mantissa is 7+1=8 bits.

Of course, the embodiment of the present disclosure is not limited thereto. For example, the first accuracy type may be FP32, and the at least two accuracy types may include BF16 and TF32, and so on. In the present disclosure, the first accuracy type and multiple low-accuracy types simulating the first accuracy type may adopt any feasible floating point type combination that meets the format requirements of the first accuracy type and the at least two accuracy types as described above, which is not specifically limited in the present disclosure.

In the data processing method provided by at least one embodiment of the present disclosure, a variety of low-accuracy floating point tensors are adopted to simulate high-accuracy floating point tensors, thereby increasing the applicable scenarios of calculation process and improving the applicability of the processor that applies the data processing method, and effectively utilizing the powerful calculation ability inherently processed by the originally provided low-accuracy floating point. In this manner, such method will not increase the overall calculation time of calculation process, but also may greatly improve the overall calculation efficiency.

The following describes the details of an execution process of a data processing method provided by at least one embodiment of the present disclosure with reference to the accompanying drawings.

For example, for each input tensor, the M input sub-tensors that are combined to represent the input tensor has the same shape as the input tensor, that is, they have the same dimensions, and the lengths of the axes in each dimension are the same. For example, if the input tensor is a two-dimensional tensor, the input tensor and the M input sub-tensors are in the form of a matrix with a row and b columns, and a and b are positive integers and both are greater than 1.

Step S20 may include: for each parameter element in the input tensor, splitting the parameter element into M sub-elements, and the M sub-elements are the elements in the M input sub-tensors that have the same positions as the parameter elements in the input tensor, and the parameter elements are expressed as the sum of the M sub-elements. It should be noted that, in at least one embodiment of the present disclosure, the “addition” of A and B may include A+B, and also include A-B, in the latter case, A-B is equivalent to A+(−B).

For example, for an input tensor A in multiple input tensors, the input tensor A is split into A=A₁+A₂+ . . . +A_{M}, where A₁, A₂, . . . , A_{M} are the M input sub-tensors that are combined to represent the input tensor A, A₁, A₂, . . . , A_{M} have at least two different accuracy types, for example, A₁, A₂, . . . , A_{M} may have M different accuracy types, i.e. their respective accuracy types are different from each other, in another example, A₁ and A₂ have a second accuracy type, and other input sub-tensors have a third accuracy type, etc., which are not specifically limited in the embodiment of the present disclosure.

For example, if the input tensor A is a two-dimensional tensor, that is, the input tensor A is in the form of a matrix with a row and b columns, the parameter element pᵢⱼ at the i-th row and the j-th column in the input tensor A is split into M sub-elements. The M sub-elements are the element p₁ᵢⱼ in the i-th row and the j-th column in the input sub-tensor A₁, the element p₂ᵢⱼ at the i-th row and the j-th column in the input sub-tensor A₂, and the element p_{Mij} at the i-th row and the j-th column in the input sub-tensor A_{M}, and the parameter element pᵢⱼ=p₁ᵢⱼ+p₂ᵢⱼ+ . . . +p_{Mij}, where i is a positive integer less than or equal to a, and j is a positive integer less than or equal to b.

For example, for each parameter element in the input tensor, the step of splitting the parameter element into M sub-elements may include: determining that the exponent and sign bit of the first sub-element in the M sub-elements are the same as the exponent and sign bit of the parameter element, and the mantissa part of the first sub-element is the same as the preceding high-order significant bit part in the significant bits of mantissa of the parameter element; determining other M−1 sub-elements in the M sub-elements except the first sub-element, and the sum of the other M−1 sub-elements is the difference between the parameter element and the first sub-element.

For example, the at least two accuracy types include a second accuracy type, the accuracy type of the first sub-element is the second accuracy type, and the total number of bits of the second accuracy type is N2, where N2 is a positive integer, and the binary representation of the first sub-element is the first N2 bits of the binary representation of the parameter element.

For example, the total number of bits of the first accuracy type is N1, and N1 is a positive integer. If the element p₁ᵢⱼ is the first sub-element, the first sub-element p₁ᵢⱼ may be obtained by the following formula:

p₁ᵢⱼ=pᵢⱼ&A (formula 1)

In the formula, “&” means AND calculation (that is, bitwise AND), A=“0b111 . . . 100 . . . 0” means that it is a binary representation, and consists of consecutive N2 1s located at the high-order and consecutive N1-N2 0s located at the low order, and the total number of bits of A is N1.

For example, the first N2 bits of the parameter element include 1 sign bit, c exponent bits used to indicate the exponent of the parameter element, and d significant bits of the mantissa located at the high-order of the significant bits of mantissa, that is, the high-order significant bit part, N2=1+c+d. For example, the first N2 bits of the binary representation of the parameter element are extracted as the first sub-element. Since the number of exponents digits of the first accuracy type is the same as that of the second accuracy type, the sign bit of the first sub-element is the same as the sign bit of the parameter element. The exponent of the first sub-element is the same as the exponent of the parameter element (that is, the c bits of the exponent part of the first sub-element are the same as the c bits of the exponent part of the parameter element). The mantissa of the first sub-element is the same as the preceding high-order significant bit part in the significant bits of mantissa of the parameter element, that is, the d mantissa significant bits of the mantissa part of the first sub-element are the same as the preceding d significant bits of the mantissa located at the high-order in the parameter element.

For example, in the significant bits of mantissa of the parameter element, the other significant bits of the mantissa other than the preceding high-order significant bit part are divided into consecutive M−1 segments, and the other M−1 sub-elements correspond to M−1 segments respectively, where the number of significant bits included in each segment is less than or equal to the number of significant bits of the mantissa of the sub-elements corresponding to the segment. That is, the other significant bits of the mantissa of the parameter element are segmented according to the number of significant bits of the mantissa of the at least two accuracy types, and each segment is taken as the mantissa part of the corresponding sub-element. In addition, in the embodiment of the present disclosure, the sum of the number of significant bits of the mantissa of the M sub-elements needs to be greater than or equal to the number of significant bits of the mantissa of the parameter element.

For example, the step of determining other M−1 sub-elements except the first sub-element among the M sub-elements may include: determining that the significant bits of the mantissa of each sub-element in the other M−1 sub-elements are the M−1 segments respectively; determining that the exponent of each of the other M−1 sub-elements is P-Qi, where P is the exponent of the parameter element, Qi is the difference in bits between the highest-order bit of the segment corresponding to the sub-element and the highest-order bit in the significant bits of mantissa of the parameter element, and P and Qi are integers.

For example, the number of significant bits of the mantissa of the first accuracy type is F1, and the at least two accuracy types corresponding to the M sub-elements include a second accuracy type and a third accuracy type. The number of significant bits of the mantissa of the second accuracy type is F2, the number of significant bits of the mantissa of the third accuracy type is F3, and F1, F2 and F3 are positive integers. The other M−1 sub-elements include the second sub-element, and the accuracy type of the second sub-element is the third accuracy type.

For example, the step of determining that the significant bits of the mantissa of each of the other M−1 sub-elements are respectively the M−1 segments includes: in response to F1-F2 being less than or equal to F3, determining that M−1 is 1, and determining that the high-order F1-F2 bits in the mantissa of the binary representation of the second sub-element are the same as the F1-F2-1-th to the 0-th bit in the mantissa part of the binary representation of the parameter element; in response to F1-F2 being greater than F3, determining that the mantissa of the binary representation of the second sub-element is the same as the F1-F2-F3-1-th to F1-F2-1-th bits in the mantissa part of the binary representation of the parameter element.

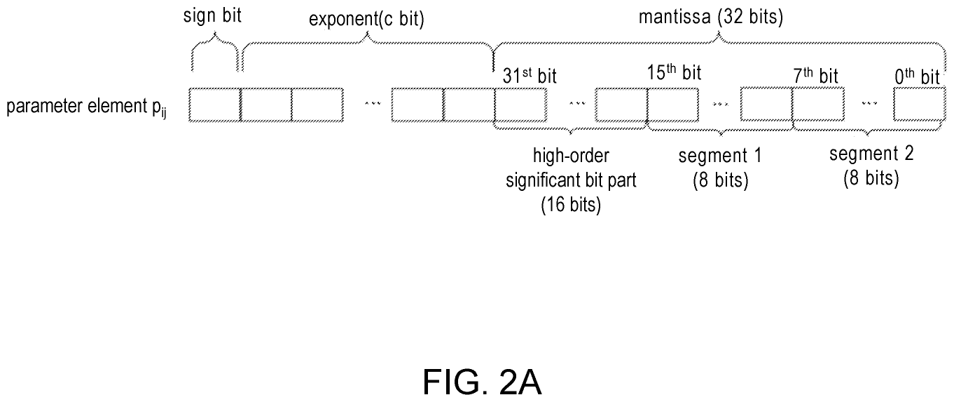

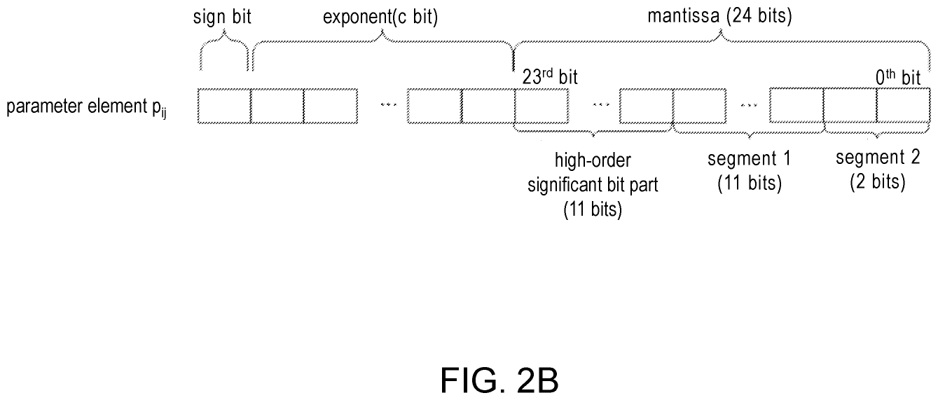

For example, in some embodiments, in response to F1-F2 being greater than F3, F1 is equal to the sum of the number of significant bits of mantissa in the respective accuracy types of the M sub-elements. Under the circumstances, the number of significant bits included in each segment is equal to the number of significant bits of the mantissa in the sub-element corresponding to the segment. For example, in a specific example, the data format of the parameter element is shown in FIG. 2A, which includes 1 sign bit, c exponent bits, and 32 significant bits of the mantissa, that is, F1=32; M=3, the number of significant bits of the mantissa of the second accuracy type is F2=16, and the number of significant bits of the mantissa of the third accuracy type is F3=8. Under the circumstances, the 16-th to the 31-st bits in FIG. 2A are taken as the high-order significant bit part. The segment 1 including the 8-th bit to the 15-th bit of the significant bits of the mantissa is taken as the mantissa part of a sub-element whose type is the third accuracy type. The segment 2 including the 0-th bit to the 7-th bit of the significant bits of the mantissa is taken as the mantissa part of another sub-element whose type is the third accuracy type.

For example, in other embodiments, F1-F2 is greater than F3, but F1 is not exactly equal to the sum of the number of significant bits of the mantissa in the respective accuracy types of the M sub-elements. Under the circumstances, the number of significant bits included in one segment in M−1 segments is less than the number of significant bits of the mantissa of the sub-element corresponding to the segment. For example, in a specific example, as shown in FIG. 2B, M=3, and F1=24, F2=11, F3=8. Under the circumstances, the 13-th to the 23-rd bits in FIG. 2B are taken as high-order significant bits. The segment 1 including the 2-nd bit to the twelve bit of the significant bits of the mantissa is taken as the mantissa part of a sub-element whose type is the second accuracy type. The segment 2 including the 1-st bit to the 0-th bit of the significant bits of the mantissa is taken as the F3-1-th bit to the F3-2 bit of the mantissa part of a sub-element whose type is the third accuracy type.

For example, when F1-F2 is greater than F3, M is greater than 2, that is, the M sub-elements might further include the third sub-element, the fourth sub-element, etc. The third sub-element, etc. may be of the second accuracy type or the third accuracy type. Of course, the accuracy type may also be other types that are different from the second accuracy type and the third accuracy type and lower than the first accuracy type, which is not specifically limited in this embodiment of the present disclosure.

For example, in other embodiments, if F1−F2 is less than or equal to F3, then M=2, that is, the M sub-elements include the first sub-element and the second sub-element. When F1-F2=F3, the mantissa of the second sub-element is the same as the 0-th to F3-1-th bits of the parameter element. When F1−F2 is less than F3, the high-order F1-F2 bits (that is, the F3-1-th bit to the F3-1−(F1−F2)-th bit) in the significant bit of the mantissa of the second sub-element are the same as the F1−F2−1-th to the 0-th bit of the parameter element. Briefly speaking, the second sub-element is the difference between the parameter element and the first sub-element.

Since the sub-element actually represents a part of the significant bits of the mantissa of the parameter element, its exponent also needs to be adapted. For example, the exponent of the sub-element is P-Qi, where P is the exponent of the parameter element, and Qi is the difference in bits between the highest-order bit of the segment corresponding to the sub-element and the highest-order bit in the significant bit of mantissa of the parameter element. For example, taking FIG. 2A as an example, Qi of the sub-element corresponding to segment 1 is the difference in bits 31−15=16 between the highest-order bit (i.e., the 15-th bit) of the segment 1 and the highest-order bit (i.e., the 31-st bit) in the significant bit of mantissa of the parameter element. Therefore, the exponent of the sub-element corresponding to segment 1 is P-16. Similarly, the exponent of the sub-element corresponding to segment 2 is P−(31−7)=P−24. Normally, the processor further adjusts the exponent of the sub-element when performing the calculation process, so that the highest-order bit in the significant bit of the mantissa is 1, and if all the bits of the mantissa are 0, the exponent is adjusted to 0.

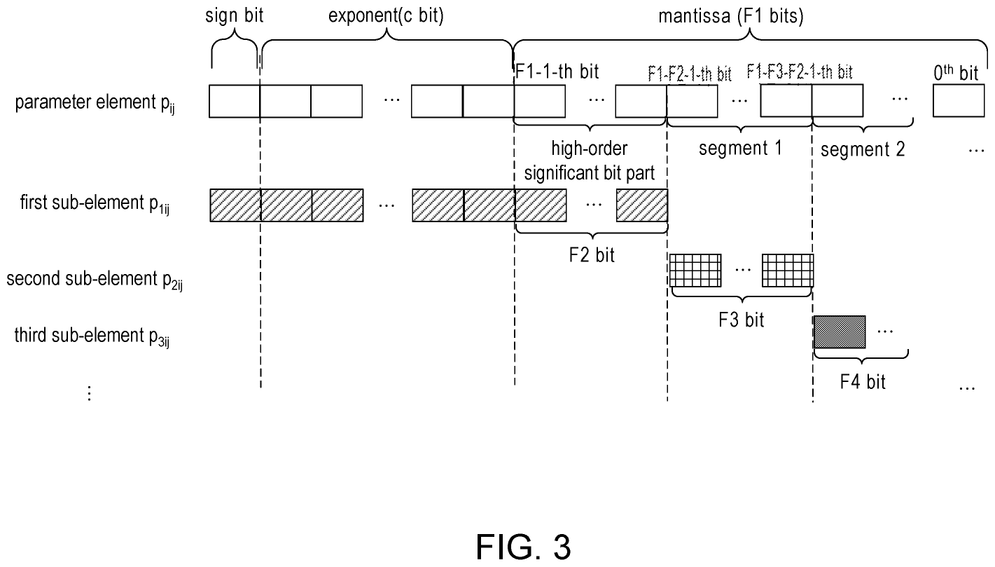

FIG. 3 is a schematic diagram of a relationship between parameter elements and sub-elements provided by at least one embodiment of the present disclosure. The following describes the determining process of the sub-element in detail with reference to FIG. 3.

As shown in FIG. 3, the parameter element pᵢⱼ includes N1 bits, where N1=1+c+F1, that is, the parameter element pᵢⱼ includes 1 sign bit, c exponent bits and F1 significant bits of mantissa. For example, as shown in FIG. 3, the sign bit is the highest-order bit of the parameter element, such as the N1−1-th bit, and the last bit of the significant bit of mantissa is the lowest-order bit of the parameter element, such as the 0-th bit. Of course, FIG. 3 is merely a schematic diagram, and may be adaptively adjusted according to the different positions of the mantissa, the exponent and the sign bit in the parameter element, which is not limited in the present disclosure.

As shown in FIG. 3, the parameter element pᵢⱼ may be divided into M sub-elements, including the first sub-element p₁ᵢⱼ, the second sub-element p₂ᵢⱼ, the third sub-element p₃ᵢⱼ . . . etc. Of course, more sub-elements may be included as needed, or only the first sub-element and the second sub-element (M=2) are included, which is not specifically limited by the embodiment of the present disclosure.

For example, the binary representation of the first sub-element p₁ᵢⱼ is the first N2 bits of the binary representation of the parameter element pᵢⱼ, that is, the sign bit of the parameter element pᵢⱼ is taken as the sign bit of the first sub-element p₁ᵢⱼ, and the exponent part of the parameter element pᵢⱼ is taken as the exponent part of the first sub-element. The F2 significant bits of the mantissa near the high-order in the significant bits of the mantissa of the parameter element pᵢⱼ are taken as the mantissa of the first sub-element p₁ᵢⱼ.

For example, M−1 sub-elements other than the first sub-element pᵢⱼ are taken to represent the difference between the parameter element and the first sub-element.

For example, the F1-F2 significant bits of mantissa excluding the high-order significant bits in the parameter element pᵢⱼ are divided into M−1 segments, and the M−1 segments correspond to the M−1 sub-elements one-to-one. Moreover, the number of significant bits included in each segment is less than or equal to the number of significant bits of the mantissa of the sub-element corresponding to the segment.

For example, as shown in FIG. 3, if F1-F2 is greater than F3, the F1-F2-F3-1-th bit to the F1-F2-1-th bit in the mantissa part of the binary representation of the parameter element pᵢⱼ are taken as segment 1, and the segment 1 is taken as the mantissa of the second sub-element p₂ᵢⱼ, that is, the mantissa part of the second sub-element is the same as the F1-F2-F3-1-th bit to the F1-F2-1-th bit in the mantissa part of the binary representation of the parameter element.

For example, as shown in FIG. 3, the M sub-elements further include a third sub-element p₃ᵢⱼ of the fourth accuracy type, the number of significant bits of the mantissa of the fourth accuracy type is F4, and F4 is a positive integer. Assuming that F1-F2-F3=F4, the F4-1-th bit to the 0-th bit in the mantissa part of the binary representation of the parameter element pᵢⱼ may be taken as segment 2, and segment 2 is taken as the mantissa of the third sub-element p₃ᵢⱼ, that is, the mantissa part of the third sub-element p₃ᵢⱼ is the same as the F4-1-th to the 0-th bit in the mantissa part of the binary representation of the parameter element p u.

As described before, the exponent of each sub-element is also adapted. For example, for the second sub-element in FIG. 2, its Qi=F2, so the exponent of the second sub-element should be P-F2. For example, for the third sub-element in FIG. 3, its Qi=F3+F2, so the exponent of the second sub-element should be P-F2-F3. For example, for the fourth sub-element in FIG. 3, its Qi=F3+F2+F4, so the exponent of the second sub-element should be P-F2-F3-F4.

For example, if expressed in a formula, when the parameter element pᵢⱼ is represented by using the combination of the first sub-element p₁ᵢⱼ, the second sub-element p₂ᵢⱼ and the third sub-element p₃ᵢⱼ, the calculation formula of the first sub-element p₁ᵢⱼ, the second sub-element p₂ᵢⱼ, and the third sub-element p₃ᵢⱼ is as follows:

p₁ᵢⱼ=pᵢⱼ&A

p₂ᵢⱼ=(pᵢⱼ−p₁ᵢⱼ)&A

p₃ᵢⱼ=pᵢⱼ−p₁ᵢⱼ−p₂ᵢⱼ (Formula 2)

The meanings of the parameters “&” and “A” of Formula 2 are similar to those of Formula 1, and will not be repeated here.

For example, in a specific example, if the first accuracy type is FP32, the second accuracy type is BF24, and the third accuracy type is BF16, then F1=24, F2=16, and F3=8, thus F1=F2+F3. The parameter element may be represented by two sub-elements, the first sub-element type may be BF24, the second sub-element type may be BF16, of course, the first sub-element type may be BF16, and the second sub-element type may be BF24.

For example, under the circumstances, the first sub-element p₁ᵢⱼ and the second sub-element p₂ᵢⱼ may be calculated using the following formula 3:

p₁ᵢⱼ=pᵢⱼ & 0xFFFFFF00

p₂ᵢⱼ=pᵢⱼ−p₁ᵢⱼ (Formula 3)

That is, the binary representation of the first sub-element is the first 24 bits of the binary representation of the parameter element, and the second sub-element is the difference between the parameter element and the first sub-element.

It should be noted that, according to different types of low-accuracy floating point and different first accuracy types adopted, the input tensor may be represented by using a combination of multiple sub-elements of different types of low-accuracy floating point. The present disclosure provides no limitation to the types of the at least two different accuracy types adopted, and the number of M input sub-tensors combined to represent the input tensors, which may be set at one's discretion according to actual needs.

In the data processing method provided by the above embodiments of the present disclosure, a variety of low-accuracy floating points are mixed to simulate high-accuracy floating points, thereby improving the applicability of calculation process, so that processors, chips, etc. applying the data processing method have broader applicable scenarios. Moreover, it is possible to fully utilize the processing performance of low-accuracy floating points originally provided by the data processing apparatus, thereby improving the calculation ability and calculation efficiency of simulated high-accuracy data formats.

For example, matrix multiplication and convolution are two common calculation processes in tensor operations. After the parameter element is divided into multiple sub-elements, the exponent of the product result of the multiplication of some sub-elements is very small. The multiplication calculation of removing this sub-element not only has no effect on the calculation result, but also reduces the number of multiplications and improves the calculation ability and calculation efficiency.

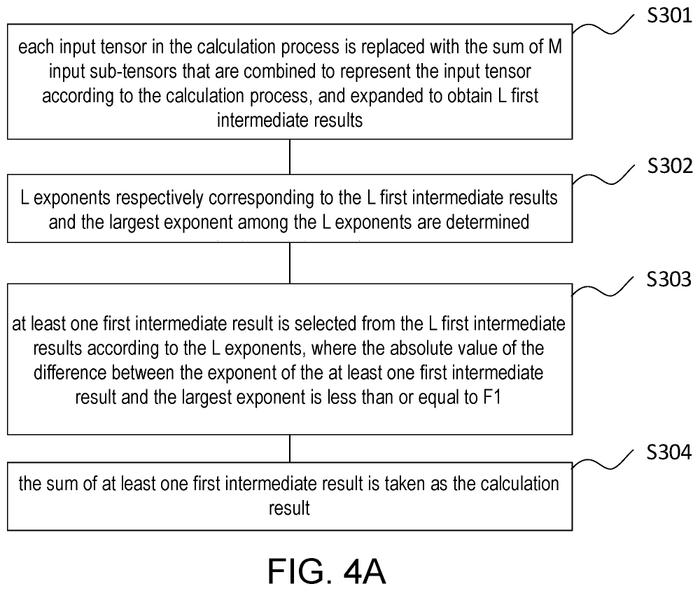

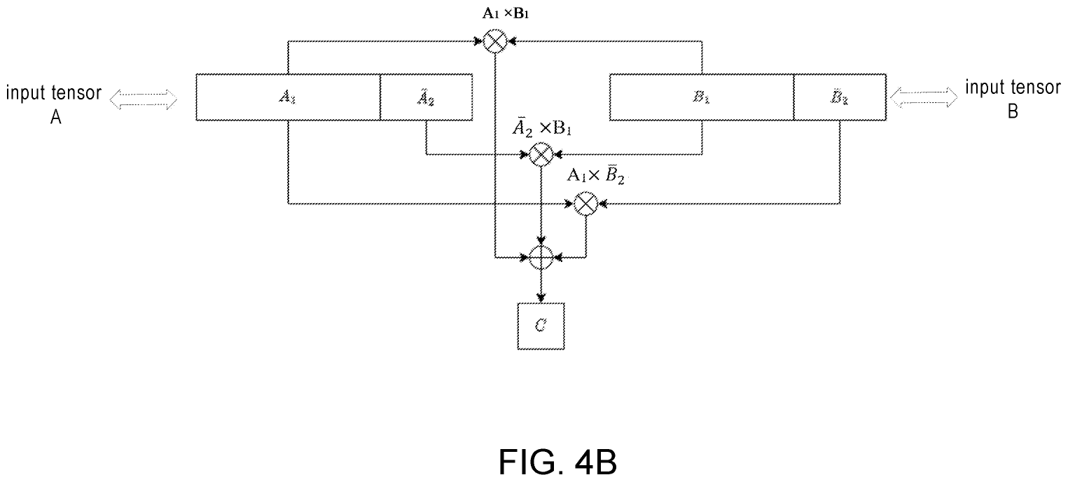

FIG. 4A is a schematic flowchart of step S30 provided by at least one embodiment of the present disclosure.

As shown in FIG. 4A, step S30 may include steps S301 to S304.

In step S301, each input tensor in the calculation process is replaced with the sum of M input sub-tensors that are combined to represent the input tensor according to the calculation process, and expanded to obtain L first intermediate results.

For example, each first intermediate result is represented as a multiplication or convolution of two input sub-tensors, where L is a positive integer greater than 1.

In step S302, L exponents respectively corresponding to the L first intermediate results and the largest exponent among the L exponents are determined.

In step S303, at least one first intermediate result is selected from the L first intermediate results according to the L exponents, where the absolute value of the difference between the exponent of the at least one first intermediate result and the largest exponent is less than or equal to F1.

In step S304, the sum of at least one first intermediate result is taken as the calculation result.

For example, the specific execution process of steps S301 to S304 is described below by taking the input tensor including input tensor A and input tensor B as an example. Of course, the present disclosure is not limited thereto, and more input tensor multiplications, convolutions, etc. may also be calculated in a similar way.

For a matrix multiplication operation or a convolution operation, the calculation result C=A×B, where x may mean matrix multiplication or convolution multiplication according to different dimensions of the input tensor, which is not specifically limited in the present disclosure.

For example, according to step S20, M input sub-tensors A₁, . . . , A_{M} that are combined to represent the input tensor A, and M input sub-tensors B₁, . . . , B_{M} that are combined to represent the input tensor B may be obtained. The specific process is as described in step S20, which is not repeated here.

First, in step S301, the input tensor A in the calculation process A×B is replaced with A₁+ . . . +A_{M}, and the input tensor B is replaced with B₁+ . . . +B_{M}, that is, C=A×B=(A₁+ . . . +A_{M})×(B₁+ . . . +B_{M}), and expanded to obtain C=A₁×B₁+ . . . +A₁×B_{M}+ . . . +A_{M}×B₁+ . . . +A_{M}×B_{M}, and there are a total of L first intermediate results. For example, A₁×B₁, A₁×B_{M}, A_{M}×B₁, and A_{M}×B_{M} are all first intermediate results, and they are expanded to obtain the sum of L first intermediate results.

Then, in step S302, L exponents respectively corresponding to the L first intermediate results and the largest exponent among the L exponents are calculated.

For example, if A₁ is the input sub-tensor composed of the first sub-elements corresponding to the parameter elements in the input tensor A, B₁ is the input sub-tensor composed of the first sub-elements corresponding to the parameter elements in the input tensor B, then the exponent corresponding to the first intermediate result A₁×B₁ is the largest exponent.

It should be noted that, since the present disclosure is concerned with the relative magnitude relationship between the exponents, the present disclosure may describe the exponents from the perspective of elements. For example, assume that the exponent of any parameter element in the input tensor A is set to be g, and the exponent value of any parameter element in the input tensor B is set to be h, then the exponent of A₁×B₁ may be expressed as g+h. The following concepts are similar to those described here, and will not be repeated.

Thereafter, in step S303, one or more first intermediate results where the absolute value of the difference between the exponent and the largest exponent is less than or less than or equal to F1 are selected from A₁×B₁, . . . , A₁×B_{M}, A_{M}×B₁, . . . , and A_{M}×B_{M}.

For example, if the first intermediate result where the absolute value of the difference between the exponent and the largest exponent is less than or equal to F1 is selected, the calculation results obtained based on these first intermediate results basically have no loss of accuracy, and the possible impact on the accuracy is limited within the range of decimal size corresponding to 2^{-F1}. The difference between the obtained calculation result and the actual calculation result is negligible. Even if the first intermediate result where the absolute value of the difference between the exponent and the largest exponent is equal to F1 is neglected, basically the accuracy of the final result will not be affected.

Finally, in step S304, the sum of the selected first intermediate results is calculated as the calculation result C.

FIG. 4B is a schematic diagram of a mixed-accuracy simulation processing process provided by at least one embodiment of the present disclosure.

As shown in FIG. 4B, in a specific example, if M=2, and the first accuracy type is FP32, the second accuracy type is BF24, and the third accuracy type is BF16, referring to the above content, after step S20, two input sub-tensors A₁ and Ā₂ corresponding to the input tensor A may be obtained. For example, the input sub-tensor A₁ is of the second accuracy type, and the input sub-tensor Ā₂ is of the third accuracy type, A₁=A & 0xFFFFFF00, and Ā₂=A−A₁. Similarly, two input sub-tensors B₁ and B₂ corresponding to the input tensor B may also be obtained.

In step S301, four first intermediate results are obtained by calculation, which are A₁×B₁, A₁×B̅₂, Ā₂×B₁, and Ā₂×B̅₂ respectively.

In step S302, the exponents of the four first intermediate results are obtained, as shown in Table 2.

TABLE 2
Exponents of the first intermediate results

| First intermediate result | A₁ × B₁ | A₁ × B̅₂ | Ā₂ × B₁ | Ā₂ × B̅₂ |
|---|---|---|---|---|
| Exponents | g + h | g + h − 16 | g + h − 16 | g + h − 32 |

For example, referring to the description of step S20, the exponent of B̅₂ is h-16, so the exponent of A₁×B̅₂ is g+h-16; similarly, the exponent of Ā₂ is g-16, and the exponent of B̅₂ is h-16, so the exponent of Ā₂×B̅₂ is g+h-32.

In step S303, the first intermediate results A₁×B₁, A₁×B̅₂ and Ā₂×B₁ where the absolute value of the difference between the exponent and the largest exponent g+h is less than or equal to 24 are selected.

Finally, in step S304, C=A₁×B₁+A₁×B̅₂+Ā₂×B₁ is calculated, so as to obtain the calculation result C.

In this manner, in the data processing method provided by at least one embodiment of the present disclosure, the accuracy of FP32 multiplication may be simulated by using one time of BF24 multiplication and two times of BF24 and BF16 mixed-accuracy multiplications, so that the calculation of FP32 multiplication may be performed, which increases the application scenarios for calculation process. Moreover, it is possible to effectively utilize the powerful calculation ability of the originally provided low-accuracy floating points BF16 and BF24, which will not increase the overall calculation time of calculation process, but can also significantly improve the overall calculation efficiency and reduce resource consumption. Such approach has high calculation ability and good performance.

In some data processing apparatuses, for example, in tensor core, the calculation ability consumption of BF24 and BF16 mixed-accuracy multiplication is between the calculation ability consumption of BF16 multiplication and BF24 multiplication.

Therefore, in order to further improve the calculation efficiency, the input sub-tensor of the second accuracy type in the first intermediate result may be further split into multiple intermediate sub-tensors of the third accuracy type. For example, the input sub-tensor of the second accuracy type in mixed-accuracy multiplication may be further split into multiple intermediate sub-tensors of the third accuracy type. Under the circumstances, the accuracy of the second accuracy type is higher than that of the third accuracy type, that is, the number of significant bits of the mantissa of the second accuracy type is greater than the number of significant bits of the mantissa of the third accuracy type. Of course, if the accuracy of the second accuracy type is lower than the accuracy of the third accuracy type, that is, the number of significant bits of the mantissa of the second accuracy type is less than the number of significant bits of the mantissa of the third accuracy type, then the input sub-tensor of the third accuracy type in the first intermediate result may be further split into multiple intermediate sub-tensors of the second accuracy type, which is not specifically limited in the present disclosure.

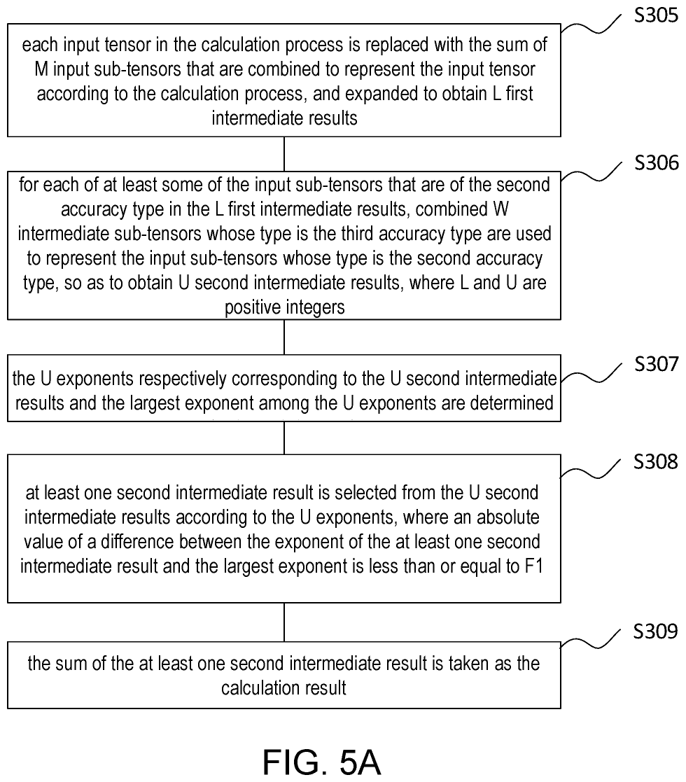

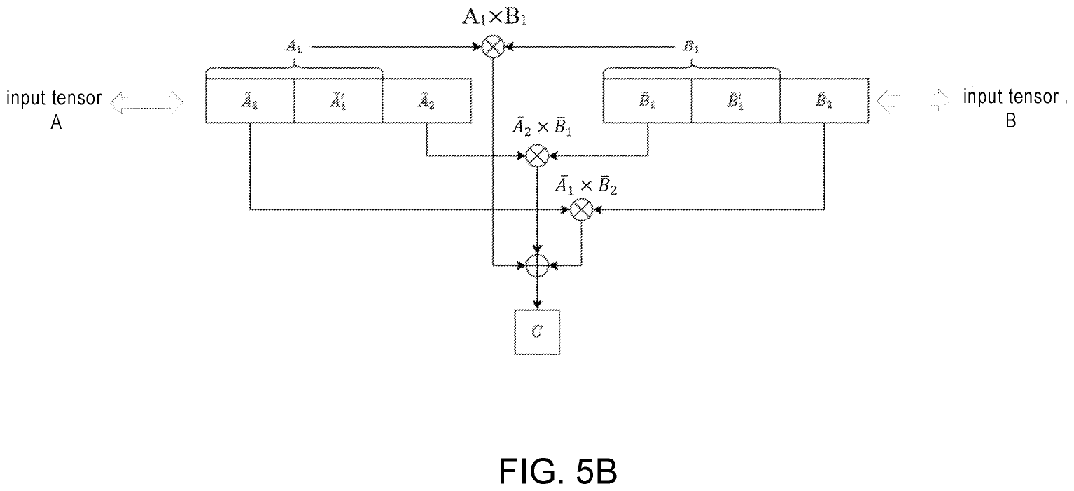

FIG. 5A is a schematic flowchart of step S30 provided by at least one embodiment of the present disclosure.

As shown in FIG. 5A, in other embodiments, step S30 includes steps S305 to S309.

In step S305, each input tensor in the calculation process is replaced with the sum of M input sub-tensors that are combined to represent the input tensor according to the calculation process, and expanded to obtain L first intermediate results.

For example, each first intermediate result is represented as a multiplication or convolution of two input sub-tensors.

In step S306, for each of at least some of the input sub-tensors that are of the second accuracy type in the L first intermediate results, combined W intermediate sub-tensors whose type is the third accuracy type are used to represent the input sub-tensors whose type is the second accuracy type, so as to obtain U second intermediate results, where L and U are positive integers.

In step S307, the U exponents respectively corresponding to the U second intermediate results and the largest exponent among the U exponents are determined.

In step S308, at least one second intermediate result is selected from the U second intermediate results according to the U exponents, where an absolute value of a difference between the exponent of the at least one second intermediate result and the largest exponent is less than or equal to F1.

In step S309, the sum of the at least one second intermediate result is taken as the calculation result.

For example, in some embodiments, part of the input sub-tensors that are of the second accuracy type in the L first intermediate results may be replaced with the sum of the W input sub-tensors that are of the third accuracy type.

Under the circumstances, step S306 may include: determining the L exponents respectively corresponding to the L first intermediate results; selecting the largest value from the L exponents, and determining L−1 first intermediate results other than the first intermediate result corresponding to the largest value among the L first intermediate results; in V first intermediate results which include input sub-tensors whose type is the second accuracy type among the L−1 first intermediate results, replacing the input sub-tensor whose type is the second accuracy type in each of the V first intermediate results with the sum of the W intermediate sub-tensors whose type is the third accuracy type, expanding to obtain W third intermediate results corresponding to each of the V first intermediate results, where the third intermediate result is expressed in the form of the multiplication or convolution of the input sub-tensor whose type is the third accuracy type and the intermediate sub-tensor, and V is a positive integer; and taking all third intermediate results corresponding to the V first intermediate results, the first intermediate result corresponding to the largest value, and L−1-V first intermediate results other than the V first intermediate results among the L−1 first intermediate results as the U second intermediate results.

For example, in other embodiments, the input sub-tensors that are of the second accuracy type in the L first intermediate results may all be replaced with the sum of the W input sub-tensors that are of the third accuracy type.

For example, the input tensor including the input tensor A and the input tensor B is still taken in the following as an example to describe the specific execution process of steps S305 to S309 in the calculation of A×B.

First, in step S305, L first intermediate results A₁×B₁, A₁×B_{M}, A_{M}×B₁, and A_{M}×B_{M}, etc. are obtained, and the specific process may refer to step S301, and the details will not be repeated.

Thereafter, in step S306, the input sub-tensors that are of the second accuracy type among the L−1 first intermediate results except A₁×B₁ with the exponential largest value among the L first intermediate results are replaced with the sum of W intermediate sub-tensors that are of the second accuracy type. For example, assuming that A₁ and B₁ are of the second accuracy type, and other M−1 input sub-tensors are of the third accuracy type, refer to the process of step S20 to obtain W intermediate sub-tensors A′₁, . . . , A′_{w} that are combined to represent A₁, and W intermediate sub-tensors B′₁, . . . , B′_{w} that are combined to represent B₁, and A′₁, . . . , A′_{w} and B′₁, . . . , B′_{w} are all third accuracy type. For V first intermediate results including A₁ and B₁ among the L−1 first intermediate results other than A₁×B₁, A₁ in these first intermediate results is replaced with A′₁+ . . . +A′_{w}, and B₁ is replaced with B′₁+ . . . +B′_{w}, and expanded to obtain the third intermediate result corresponding to each of the V first intermediate results. Taking A₁×B_{M} as an example, A₁ is replaced with A′₁+ . . . +A′_{w}, so that A₁×B_{M}=(A′₁+ . . . +A′_{w})×B_{M}=A′₁×B_{M}+ . . . +A′_{w}×B_{M}, thereby obtaining W third intermediate results A′₁×B_{M}, . . . , A′_{w}×B_{M} corresponding to the first intermediate result A₁×B_{M}.

The first intermediate results A₁×B₁, V*W third intermediate results corresponding to the first intermediate results including A₁ and B₁, and L−1-V first intermediate results which include neither A₁ nor B₁ in the L intermediate results are taken as U second intermediate results, where U=V*W+L−V.

Afterwards, in step S307, the U exponents corresponding to the U second intermediate results and the largest exponent therein are determined. For the specific process, reference may be made to step S302, and the details will not be repeated here.

After that, in step S308, at least one second intermediate result where an absolute value of a difference between the exponent and the largest exponent is less than or equal to F1 is selected from the U second intermediate results.

Finally, in step S309, the sum of the at least one second intermediate result is calculated as the final calculation result.

Therefore, compared with the calculation results obtained in steps S301 to S304, the calculation process of steps S305 to S309 omits the mixed-accuracy multiplication, and replaces the original mixed-accuracy multiplication with the multiplication of the same type of accuracy, thus improving calculation ability, improving calculation efficiency, and reducing resource consumption without affecting the accuracy. Moreover, since the two multiplication operations of the second-accuracy type corresponding to the largest exponent are retained, and the input sub-tensors of the second-accuracy type in other first intermediate results are replaced with the sum of intermediate sub-tensors of the third-accuracy type, it is possible to use two multiplication operations of the second accuracy type to complete W*W multiplication operations of the third accuracy type, thereby reducing the number of multiplication operations. Compared with replacing all input sub-tensors with the sum of intermediate sub-tensors of the third accuracy type, the calculation ability is further improved, the calculation efficiency is enhanced, and the resource consumption is reduced.

FIG. 5B is a schematic diagram of a mixed-accuracy simulation processing process provided by at least one embodiment of the present disclosure.

As shown in FIG. 5B, in a specific example, if the first accuracy type is FP32, the second accuracy type is BF24, and the third accuracy type is BF16, referring to the above content, after step S20, the two input sub-tensors A₁ and Ā₂ corresponding to the input tensor A may be obtained. For example, the input sub-tensor A₁ is of the second accuracy type, and the input sub-tensor Ā₂ is of the third accuracy type. Similarly, two input sub-tensors B₁ and B̅₂ corresponding to the input tensor B may also be obtained.

In step S305, four first intermediate results are obtained by calculation, which are A₁×B₁, A₁×B̅₂, Ā₂×B₁, and Ā₂×B̅₂ respectively.

In step S306, the exponents of the four first intermediate results are obtained, as shown in Table 2. Refer to step S20, two intermediate sub-tensors Ā₁ and Ā′₁ of type BF16 that are combined to represent A₁ are obtained, and Ā₁=A₁ & 0xFFFF00, Ā′₁=A₁−Ā₁. Similarly, two intermediate sub-tensors B̅₁ and B̅′₁ of type BF16 that are combined to represent B₁ are obtained; then, A₁ in A₁×B̅₂, Ā₂×B₁, and Ā₂×B₂ is replaced with Ā₁+Ā′₁, and B₁ is replaced with B̅₁+B̅′₁, and expanded to obtain the formula 4 below:

$$\begin{matrix}C = {A}_{1} {B}_{1} + {A}_{1} {\overline{B}}_{1} + {\overline{A}}_{2} {B}_{1} + {\overline{A}}_{2} {\overline{B}}_{2} \\ = {A}_{1} {B}_{1} + ( {\overline{A}}_{1} + {\overline{A}}_{1}^{′} ) \cdot {\overline{B}}_{2} + {\overline{A}}_{2} \cdot ( {\overline{B}}_{1} + {\overline{B}}_{1}^{′} ) + {\overline{A}}_{2} {\overline{B}}_{2} \\ = {A}_{1} {B}_{1} + {\overline{A}}_{1} {\overline{B}}_{2} + {\overline{A}}_{1}^{′} {\overline{B}}_{2} + {\overline{A}}_{2} {\overline{B}}_{1} + {\overline{A}}_{2} {\overline{B}}_{1}^{′} + {\overline{A}}_{2} {\overline{B}}_{2}\end{matrix} \qquad ( Formula 4 )$$

In this manner, six second intermediate results are obtained, which are A₁B₁, Ā₁B̅₂, Ā₂B̅₁, Ā₂B̅′₁ and Ā₂B̅₂ respectively.

Afterwards, in step S306, the exponents of the six second intermediate results are determined, as shown in Table 3.

TABLE 3
Exponents of the second intermediate results

| | Second intermediate results | | | | | |
|---|---|---|---|---|---|---|
| | A₁ × | Ā₁ × | Ā′₁ × | Ā₂ × | Ā₂ × | Ā₂ × |
| | B₁ | B̅₂ | B̅₂ | B̅₁ | B̅′₁ | B̅₂ |
| Exponents | g + h | g + h − | g + h − | g + h − | g + h − | g + h − |
| | | 16 | 24 | 16 | 24 | 32 |

For example, referring to the description of step S20, the exponent of Ā₁ is g, and the exponent of B̅₂ is h-16, so that the exponent of Ā₁×B̅₂ is g+h-16; similarly, the exponent of Ā₂ is g-16, the exponent of B̅′₁ is h-8, so the exponent of Ā₂×B̅′₁ is g+h-24.

Then, in step S308, at least one second intermediate result where an absolute value of the difference between the exponent and the largest exponent is less than or equal to F1 is selected from the six second intermediate results. For example, as mentioned earlier, since the number of significant bits in the mantissa part of FP32 is 24, the second intermediate result whose exponent is less than or equal to g+h-24 has little effect on the final calculation result, so A₁×B₁, Ā₁×B̅₂, and Ā₂×B̅₁ may be selected for the final calculation. In this manner, it is possible to ensure accuracy, and further reduce the number of multiplications, so a balance between calculation accuracy and calculation ability may be achieved.

Finally, in step S309, C=A₁×B₁+Ā₁×B̅₂+Ā₂×B̅₁ is calculated, so as to obtain the final calculation result C.

In this manner, in the data processing method provided by at least one embodiment of the present disclosure, the accuracy of FP32 multiplication may be simulated by using one time of BF24 multiplication and two times of BF24 and BF16 multiplications, which reduces resource consumption, increases calculation ability and improves performance.

For example, in some chips or processors, the calculation ability consumption of BF24 multiplication is twice that of BF16, that is, performing one time of BF24 multiplication is equivalent to performing two times of BF16 multiplications. If Aland B₁ in the first intermediate result are both split into the sum of intermediate sub-tensors of two BF16, it would be necessary to perform six times of BF16 multiplications in the end. This disclosure uses one BF24 multiplication to replace four times of BF16 multiplications, even if the calculation ability consumption of BF24 multiplication is twice the calculation ability consumption of BF16, the data processing method provided by the present disclosure also reduces the resource consumption of calculation process, has higher efficiency, better performance, and better theoretical calculation ability.

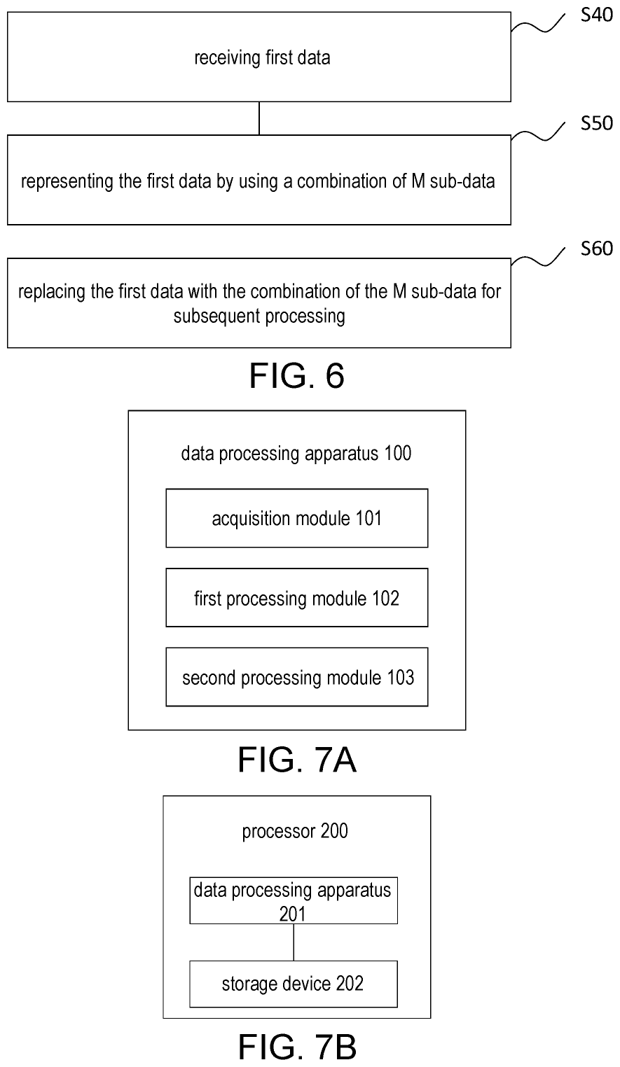

At least one embodiment of the present disclosure further provides a data processing method; FIG. 6 is a flowchart of a data processing method provided by at least one embodiment of the present disclosure.

As shown in FIG. 6, the data processing method includes at least steps S40 to S60.

In step S40, the first data is received. For example, the first data is of the first accuracy type.

In step S50, M sub-data is combined to represent the first data.

For example, the first data is the sum of M sub-data.

For example, the M data has at least two different accuracy types, and the at least two accuracy types are both different from the first accuracy type, and M is an integer greater than 1. The first accuracy type and the at least two accuracy types are both floating point types. The exponents digits in the first accuracy type is the same as the exponents digits in the at least two accuracy types. The accuracy of the first accuracy type is higher than the accuracy of any one of the at least two accuracy types.

For the specific execution process of step S50, reference may be made to the relevant description of the foregoing step S20, and details will not be repeated.

In step S60, the first data is replaced by using the combination of the M sub-data for subsequent processing.

For example, the subsequent processing here may include the aforementioned calculation process, or, the subsequent processing may also include any other processing required in the process of using the first data, and the present disclosure does not limit the specific operation of the “subsequent processing”.

In the data processing method provided by at least one embodiment of the present disclosure, multiple low-accuracy sub-data of mixed-accuracy types are adopted to simulate high-accuracy first data, so that the processor using the data processing method supports the calculation of high-accuracy data formats that might not be supported originally, thereby increasing the applicable scenarios of calculation process, improving the applicability of processors that apply this data processing method, and effectively utilizing the powerful calculation ability inherently processed by the originally provided low-accuracy floating point. In this manner, such method will not increase the overall calculation time of calculation process, but also may greatly improve the overall calculation efficiency.

At least one embodiment of the present disclosure further provides a data processing apparatus. FIG. 7A is a schematic block diagram of a data processing apparatus according to at least one embodiment of the present disclosure.

As shown in FIG. 7A, the data processing apparatus 100 includes an acquisition module 101, a first processing module 102 and a second processing module 103.

For example, the acquisition module 101 is configured to acquire multiple input tensors as input parameters for calculation process, where the multiple input tensors are of the first accuracy type.

For example, the first processing module 102 is configured to, for each of the input tensors, represent the input tensor by using a combination of M input sub-tensors, where the M input sub-tensors have at least two different accuracy types, the at least two accuracy types are both different from the first accuracy type, and M is an integer greater than 1.

For example, a second processing module 103 is configured to, for each of the input tensors, replace the input tensor by using the M input sub-tensors that are combined to represent the input tensor, perform the calculation process, and obtain a calculation result.

For example, the first accuracy type and the at least two accuracy types are both floating point types, and the exponents digits in the first accuracy type is the same as the exponents digits in the at least two accuracy types, and the accuracy of the first accuracy type is higher than the accuracy of any one of the at least two accuracy types.

For example, the calculation results may be directly output from the data processing apparatus 100 and transmitted to other components that need to use the calculation results, such as a storage device or other calculation devices.

For example, the acquisition module 101, the first processing module 102 and the second processing module 103 include codes and programs stored in the memory, and the acquisition module 101, the first processing module 102 and the second processing module 103 are implemented, for example, as a central processing unit (CPU) or other forms of processing units with data processing capabilities and/or instruction execution capabilities. The processing units may be general-purpose processors, and may also be single-chip microcomputers, microprocessors, digital signal processors, specific-purpose image processing chips, or field programmable logic arrays, etc. The acquisition module 101, the first processing module 102 and the second processing module 103 execute the code and program to implement some or all of functions of the acquisition module 101, the first processing module 102 and the second processing module 103. For example, the acquisition module 101, the first processing module 102 and the second processing module 103 may be one circuit board or a combination of multiple circuit boards for implementing the functions as described above. In the embodiments of the present disclosure, the one circuit board or the combination of multiple circuit boards may include: (1) one or more processors; (2) one or more non-transitory memories connected to the processors; and (3) a firmware stored in the memory executable by the processor.

It should be noted that the acquisition module 101 may be used to implement step S10 shown in FIG. 1, the first processing module 102 may be used to implement step S20 shown in FIG. 1, and the second processing module 103 may be used to implement step S30 shown in FIG. 1. Therefore, for the specific description of the functions that can be implemented by the acquisition module 101, the first processing module 102 and the second processing module 103, reference may be made to the relevant descriptions of steps S10 to S30 in the above-mentioned embodiments of the data processing method, and details are not repeated here. In addition, the data processing apparatus 100 may achieve technical effects similar to those of the aforementioned data processing method, and details will not be repeated here.

It should be noted that, in at least one embodiment of the present disclosure, the data processing apparatus 100 may include more or less circuits or units, and the connection relationship between the various circuits or units is not limited, and may be set based on actual needs. The specific structure of each circuit or unit is not limited, and may be composed of analog devices, digital chips, or other suitable ways according to circuit principles.

For example, in some embodiments, the data processing apparatus 100 may be, for example, a tensor core. Of course, the data processing apparatus 100 may also be implemented as other chips, processors, etc. that need to perform calculation process, including but not limited to image processing unit (GPU), data processing unit (DPU), tensor processing unit (TPU), neural network processing unit (NPU), AI accelerator, etc., which are not specifically limited in the present disclosure.

At least one embodiment of the present disclosure further provides a processor. FIG. 7B is a schematic block diagram of a data processor according to at least one embodiment of the present disclosure.

As shown in FIG. 7B, the processor 200 includes the data processing apparatus 201 according to any embodiment of the present disclosure. Regarding the structure, function, and technical effect of the data processing apparatus 201, reference is made to the aforementioned data processing apparatus 100, and details are not repeated here.

For example, the processor 200 may further include a storage device 202 configured to input a plurality of input tensors into the acquisition module 101.

For example, the storage device 203 is further configured to receive and store the calculation results.

For example, the storage device 203 may include a storage device of any structure capable of storing data functions, such as a memory, a cache, and the like.

Of course, according to actual needs, the processor 200 may further include more components for performing subsequent processing of the calculation result, which is not specifically limited in the present disclosure.

For example, the processor 200 may be implemented as a single-chip package (e.g., SOC chip), a multi-chip package (e.g., Chiplet), etc., according to actual needs, which is not limited in the present disclosure.

For example, in an embodiment, the data processing apparatus 200 may be a GPU, and the data processing apparatus 201 may be a tensor core.

At least one embodiment of the present disclosure further provides a data processing method. For example, the data processing method includes: receiving a data calculation instruction, where the data calculation instruction includes a plurality of input tensors as calculation input parameters; and using the data processing unit to execute the data calculation instruction after parsing the data calculation instruction.

For example, the step of using the data processing unit to execute the data calculation instruction includes: acquiring multiple input tensors as input parameters of the calculation process, where the multiple input tensors are of the first accuracy type; for each input tensor, using the M input sub-tensors that are combined to represent the input tensor, where the M input sub-tensors have at least two different accuracy types, the at least two accuracy types are both different from the first accuracy type, and M is an integer greater than 1; for each of the input tensors, replacing the input tensors with the M input sub-tensors that are combined to represent the input tensor, and performing the calculation process to obtain a calculation result.

For example, the first accuracy type and the at least two accuracy types are both floating point types, the exponents digits in the first accuracy type is the same as the exponents digits in the at least two accuracy types, the accuracy of the first accuracy type is higher than the accuracy of any one of the at least two accuracy types.

For example, the data processing method provided by at least one embodiment of the present disclosure may be applied to the processor 200 shown in FIG. 7A.

For example, in the data processing method provided by at least one embodiment of the present disclosure, a data calculation instruction is provided, and the data calculation instruction includes a plurality of tensors as input parameters of the calculation process. For example, after receiving the data calculation instruction, the processor parses the data calculation instruction, for example, decodes the data calculation instruction, generates a microinstruction and sends the microinstruction to an instruction distribution unit; the instruction distribution unit sends the microinstruction to a corresponding dispatch queue according to the type of the microinstruction. In response to the microinstruction, when multiple input tensors (all or required parts) are ready, the data is read and the related operations of the data calculation instruction are executed by the data processing unit.

For the specific process of using the data processing unit to execute the data calculation instruction, reference may be made to steps S10 to S30 in the data processing method described above, and details will not be repeated.

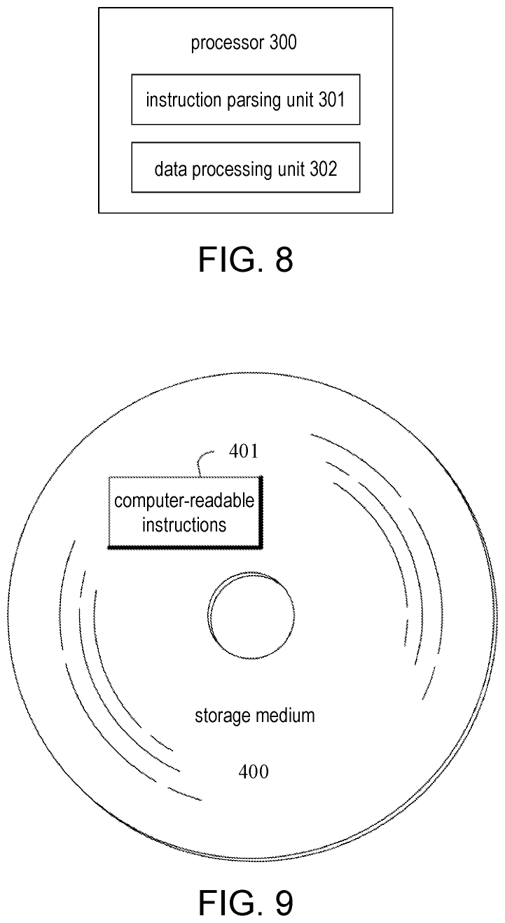

FIG. 8 is a schematic structural diagram of a processor provided by at least one embodiment of the present disclosure. As shown in FIG. 8, a processor 300 includes an instruction parsing unit 301 and a data processing unit 302.

For example, the instruction parsing unit 301 is configured to receive and parse a data calculation instruction, where the data calculation instruction includes a plurality of input tensors as calculation input parameters.

For example, after the instruction parsing unit parses the data calculation instruction, the data processing unit 302 executes the data processing method according to any embodiment of the present disclosure.

Specifically, when the upper-layer software based on the processor (such as AI applications, HPC applications, and scientific computing applications, etc.) is able to send data calculation instructions for calculation process to the processor (such as CPU or GPU) through a uniformly packaged function library, the data calculation instruction may carry an input tensor. When the processor receives the data calculation instruction, the instruction parsing unit 301 parses the data calculation instruction to obtain the input tensor, and the processor schedules the data processing unit to perform the calculation task on the input tensor. For example, after parsing the data calculation instruction, the processor may store the input tensors in the data calculation instruction into a register or memory, so that when the data processing unit performs calculation process, the data processing unit may obtain multiple input tensors as calculation input parameters from the register or memory.

For the specific process of using the data processing unit to execute the data calculation instruction, reference may be made to steps S10 to S30 in the data processing method described above, and details will not be repeated.

FIG. 9 is a schematic diagram of a non-transitory computer-readable storage medium provided by at least one embodiment of the present disclosure. For example, as shown in FIG. 9, a storage medium 400 may be a non-transitory computer-readable storage medium on which one or more computer-readable instructions 401 may be stored non-transitorily. For example, the computer readable instructions 401 may, when being executed by a processor, perform one or more steps in the data processing method described above.

For example, the storage medium 400 may be applied to the processor 200, for example, the storage medium 400 may include the storage device 202 in the processor 200.

For example, a storage device may include any combination of one or more computer program products, which may include various forms of computer-readable storage media, such as volatile memory and/or nonvolatile memory. Volatile memory may include, for example, random access memory (RAM) and/or cache, among others. Non-volatile memory may include, for example, read only memory (ROM), hard disk, erasable programmable read only memory (EPROM), portable compact disk read only memory (CD-ROM), USB memory, flash memory, and the like. One or more computer-readable instructions may be stored on the computer-readable storage medium, and the processor may execute the computer-readable instructions to implement various functions of the processor. Various application programs, various data and the like may also be stored in the storage medium.

For example, the storage medium may include a memory card of a smartphone, a storage component of a tablet computer, a hard disk of a personal computer, random access memory (RAM), read only memory (ROM), erasable programmable read only memory (EPROM), portable compact disk read only memory (CD-ROM), flash memory, or any combination of the above storage media, and may also be other suitable storage media.

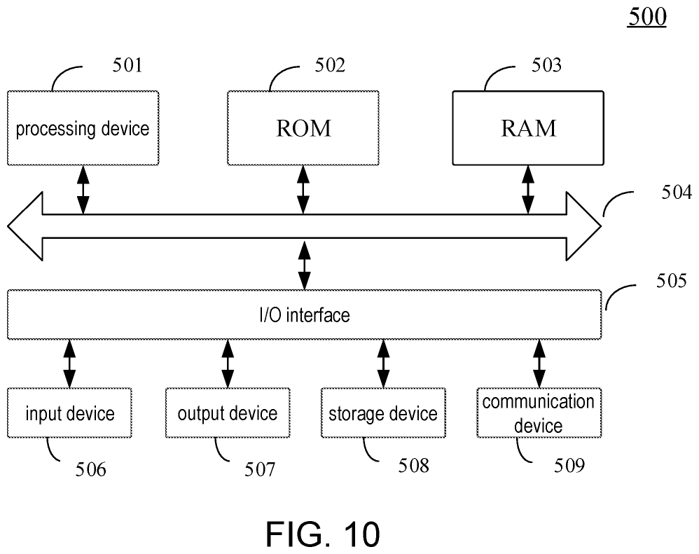

FIG. 10 is a schematic block diagram of an electronic device according to an embodiment of the present disclosure. As shown in FIG. 10, the electronic device 500 is, for example, suitable for implementing the data processing method provided by the embodiments of the present disclosure. It should be noted that the components of the electronic device 500 shown in FIG. 10 are only exemplary and not limiting, and the electronic device 500 may further have other components according to actual application requirements.

As shown in FIG. 10, the electronic device 500 may include a processing device (e.g., a central processing unit, a graphics processor, etc.) 501 that may perform various appropriate actions and processes according to non-transitory computer-readable instructions stored in a memory to achieve various functions.

For example, the computer readable instructions, when being executed by the data processing apparatus 501, may perform one or more steps in the data processing method according to any of the above embodiments. It should be noted that, for a detailed description of the data processing procedure, reference may be made to the relevant descriptions in the above-mentioned embodiments of the data processing, and details will not be repeated.

For example, a memory may include any combination of one or more computer program products, which may include various forms of computer-readable storage media, such as volatile memory and/or nonvolatile memory. Volatile memory may include, for example, random access memory (RAM) 503 and/or cache, among others. For example, computer readable instructions may be loaded into random access memory (RAM) 503 from the storage device 508 to execute the computer readable instructions. Non-volatile memory may include, for example, read only memory (ROM) 502, hard disk, erasable programmable read only memory (EPROM), portable compact disk read only memory (CD-ROM), USB memory, flash memory, and the like. Various applications and various data, such as style images, and various data used and/or generated by the application programs, may also be stored in the computer-readable storage medium.

For example, the data processing apparatus 501, the ROM 502, and the RAM 503 are connected to each other through a bus 504. An input/output (I/O) interface 505 is also connected to the bus 504.

Typically, the following devices may be connected to the I/O interface 505: including an input device 506, such as a touch screen, a touchpad, a keyboard, a mouse, a camera, a microphone, an accelerometer, a gyroscope, etc.; including an output device 507, such as a liquid crystal display (LCD), a speaker, a vibrator, etc.; including a storage device 508, such as a magnetic tape, a hard disk, a flash memory, etc.; and including a communication device 509. The communication device 509 may allow the electronic device 500 to communicate with other electronic devices in a wireless or wired manner to exchange data. While FIG. 10 shows the electronic device 500 having various means, it should be understood that not all of the illustrated means are required to be implemented or provided, and the electronic device 500 may alternatively implement or provide more or less means. For example, the processor 501 may control other components in the electronic device 500 to perform desired functions. The processor 501 may be a device with data processing capability and/or program execution capability, such as a central processing unit (CPU), a tensor processing unit (TPU), or a graphics processing unit (GPU). The central processing unit (CPU) may having X86, ARM, RISC-V architecture, etc. The GPU may be integrated directly into the SOC, directly integrated into the motherboard, or built into the Northbridge chip of the motherboard.

In the present disclosure, the following points need to be emphasized.

(1) The drawings of the embodiments of the present disclosure only relate to the structures involved in the embodiments of the present disclosure, and other structures may refer to general designs.

(2) The embodiments of the present disclosure and the features in the embodiments may be combined with each other to obtain new embodiments without conflict.

The above descriptions are only specific embodiments of the present disclosure, but the scope to be protected by the present disclosure is not limited thereto, and the scope to be protected by the present disclosure should be subject to the protection scope of the claims.

What is claimed is:

1. A data processing method, comprising:
acquiring a plurality of input tensors as input parameters for a calculation process, wherein the plurality of input tensors are of a first accuracy type;
for each of the input tensors, using M input sub-tensors that are combined to represent the input tensors, wherein the M input sub-tensors have at least two accuracy types, the at least two accuracy types and the first accuracy type are different from each other, and M is an integer greater than 1;
for each of the input tensors, replacing the input tensors with the combined M input sub-tensors, and performing the calculation process to obtain a calculation result.

2. The data processing method according to claim 1, wherein for each of the input tensors, the M input sub-tensors have the same shape as the input tensors,
for each of the input tensors, step of using the M input sub-tensors that are combined to represent the input tensors comprises:
for each parameter element in the input tensors, splitting the parameter element into M sub-elements,
wherein the M sub-elements are elements in the M input sub-tensors that have the same positions as the parameter elements in the input tensors, and the parameter elements are expressed as a sum of the M sub-elements.

3. The data processing method according to claim 2, wherein for each of the parameter elements in the input tensors, step of splitting the parameter element into the M sub-elements comprises:
determining that an exponent and a sign bit of a first sub-element in the M sub-elements are the same as an exponent and a sign bit of the parameter element, and significant bits of mantissa of the first sub-element is the same as a preceding high-order significant bit part in significant bits of mantissa of the parameter element;
determining other M−1 sub-elements in the M sub-elements except the first sub-element, and a sum of the other M−1 sub-elements is a difference between the parameter element and the first sub-element.

4. The data processing method according to claim 3, wherein the at least two accuracy types comprise a second accuracy type,
an accuracy type of the first sub-element is the second accuracy type, and a total number of bits of the second accuracy type is N2, N2 is a positive integer,
a binary representation of the first sub-element is the first N2 bits of a binary representation of the parameter element.

5. The data processing method according to claim 3, wherein in the significant bits of the mantissa of the parameter element, other significant bit part except the preceding high-order significant bit part are divided into consecutive M−1 segments,
the other M−1 sub-elements correspond to the M−1 segments respectively, wherein the number of significant bits comprised in each of the segments is less than or equal to the number of significant bits of mantissa of a sub-element corresponding to the segment,
step of determining the other M−1 sub-elements in the M sub-elements except the first sub-element comprises:
determining that the significant bits of the mantissa of each sub-element in the other M−1 sub-elements are the M−1 segments respectively;
determining that an exponent of each of the other M−1 sub-elements is P-Qi, wherein P is an exponent of the parameter element, Qi is a difference in bits between highest-order bit of a segment corresponding to the sub-element and highest-order bit in the significant bits of the mantissa of the parameter element, and P and Qi are integers.

6. The data processing method according to claim 5, wherein the number of significant bits of mantissa of the first accuracy type is F1,
the at least two accuracy types comprise a second accuracy type and a third accuracy type, the number of significant bits of mantissa of the second accuracy type is F2, the number of significant bits of mantissa of the third accuracy type is F3, and F1, F2 and F3 are positive integers,
the other M−1 sub-elements comprise a second sub-element, and an accuracy type of the second sub-element is the third accuracy type,
wherein step of determining that the significant bits of the mantissa of each of the other M−1 sub-elements are respectively the M−1 segments comprises:
in response to F1-F2 being less than or equal to F3, determining that M−1 is 1, and determining that high-order F1-F2 bits in the significant bits of the mantissa of a binary representation of the second sub-element are the same as the F1-F2-1-th to the 0-th bit in the significant bits of the mantissa of a binary representation of the parameter element;
in response to F1-F2 being greater than F3, determining that the significant bits of the mantissa of the binary representation of the second sub-element are the same as the F1-F2-F3-1-th to F1-F2-1-th bits in the significant bits of the mantissa of the binary representation of the parameter element.

7. The data processing method according to claim 6, wherein in response to F1-F2 being greater than F3, F1 is equal to a sum of the number of the significant bits of the mantissa in the respective accuracy types of the M sub-elements.

8. The data processing method according to claim 1, wherein the calculation process at least comprises a convolution operation or a matrix multiplication operation,
the number of significant bits of mantissa of the first accuracy type is F1, and F1 is a positive integer,
the at least two accuracy types comprise a second accuracy type and a third accuracy type,
for each of the input tensors, step of replacing the input tensors with the combined M input sub-tensors, and performing the calculation process to obtain the calculation result comprises:
replacing each of the input tensors in the calculation process with a sum of the M input sub-tensors according to the calculation process, and obtaining L first intermediate results, wherein each of the first intermediate results is expressed as a multiplication or a convolution of the two input sub-tensors, L is a positive integer greater than 1;
determining L exponents respectively corresponding to the L first intermediate results and a largest exponent among the L exponents;
selecting at least one first intermediate result from the L first intermediate results according to the L exponents, wherein an absolute value of a difference between an exponent of the at least one first intermediate result and the largest exponent is less than or equal to F1;
taking a sum of the at least one first intermediate result as the calculation result.

9. The data processing method according to claim 1, wherein the calculation process at least comprises a convolution operation or a matrix multiplication operation,
the number of significant bits of mantissa of the first accuracy type is F1, and F1 is a positive integer,
the at least two accuracy types comprise a second accuracy type and a third accuracy type,
for each of the input tensors, step of replacing the input tensors with the combined M input sub-tensors, and performing the calculation process to obtain the calculation result comprises:
replacing each of the input tensors in the calculation process with a sum of the M input sub-tensors according to the calculation process, and obtaining L first intermediate results, wherein each of the first intermediate results is expressed as a multiplication or a convolution of the two input sub-tensors;
for each of at least some of the input sub-tensors that are of the second accuracy type in the L first intermediate results, using combined W intermediate sub-tensors whose type is the third accuracy type to represent input sub-tensors whose type is the second accuracy type, so as to obtain U second intermediate results, L and U are positive integers;
determining U exponents respectively corresponding to the U second intermediate results and a largest exponent among the U exponents;
selecting at least one second intermediate result from the U second intermediate results according to the U exponents, wherein an absolute value of a difference between an exponent of the at least one second intermediate result and the largest exponent is less than or equal to F1;
taking a sum of the at least one second intermediate result as the calculation result.

10. The data processing method according to claim 9, wherein for each of the at least some of the input sub-tensors that are of the second accuracy type in the L first intermediate results, step of using the combined W intermediate sub-tensors whose type is the third accuracy type to represent the input sub-tensors whose type is the second accuracy type, so as to obtain the U second intermediate results comprises:
determining L exponents respectively corresponding to the L first intermediate results;
selecting a largest value from the L exponents, determining L−1 first intermediate results other than a first intermediate result corresponding to the largest value among the L first intermediate results;
in V first intermediate results which comprise input sub-tensors whose type is the second accuracy type among the L−1 first intermediate results, replacing input sub-tensors whose type is the second accuracy type in each of the V first intermediate results with a sum of the W intermediate sub-tensors, and obtaining W third intermediate results corresponding to each of the V first intermediate results, wherein the third intermediate result is expressed in a form of a multiplication or a convolution of input sub-tensors whose type is the third accuracy type and intermediate sub-tensors, V is a positive integer;
taking all of the third intermediate results corresponding to the V first intermediate results, the first intermediate result corresponding to the largest value, and L−1-V first intermediate results other than the V first intermediate results among the L−1 first intermediate results as the U second intermediate results.

11. The data processing method according to claim 1, wherein the first accuracy type and the at least two accuracy types are both floating point types.

12. The data processing method according to claim 1, wherein exponent digits in the first accuracy type are the same as exponent digits in the at least two accuracy types.

13. The data processing method according to claim 1, wherein an accuracy of the first accuracy type is higher than an accuracy of any one of the at least two accuracy types.

14. The data processing method according to claim 1, the first accuracy type is FP32, the at least two accuracy types comprise BF16 and BF24, the number of exponent digits of the BF16 is 8, the number of significant bits of mantissa of the BF16 is 8, the number of exponent digits of the BF24 is 8, the number of significant bits of mantissa of the BF24 is 16,
each of the input tensors is represented by using a combination of one input sub-tensor whose type is BF16 and one input sub-tensor whose type is BF24.

15. The data processing method according to claim 1, wherein the calculation process at least comprises a conventional calculation operation, and the conventional calculation operation comprises addition and subtraction.

16. A data processing apparatus, comprising:
an acquisition module, configured to acquire a plurality of input tensors as input parameters for a calculation process, wherein the plurality of input tensors are of a first accuracy type;
a first processing module, configured to, for each of the input tensors, use M input sub-tensors that are combined to represent the input tensors, wherein the M input sub-tensors have at least two accuracy types, the at least two accuracy types and the first accuracy type are different from each other, and M is an integer greater than 1;
a second processing module, configured to, for each of the input tensors, replace the input tensors with the M input sub-tensors, perform the calculation process, and obtain a calculation result.

17. A data processing method, comprising:
receiving a data calculation instruction, wherein the data calculation instruction comprises a plurality of input tensors as calculation input parameters,
after parsing the data calculation instruction, using a data processing unit to execute the data calculation instruction,
wherein step of using the data processing unit to execute the data calculation instruction comprises:
acquiring a plurality of input tensors as input parameters for a calculation process, wherein the plurality of input tensors are of a first accuracy type;
for each of the input tensors, using M input sub-tensors that are combined to represent the input tensors, wherein the M input sub-tensors have at least two accuracy types, the at least two accuracy types and the first accuracy type are different from each other, and M is an integer greater than 1;
for each of the input tensors, replacing the input tensors with the M input sub-tensors, and performing the calculation process to obtain a calculation result.
